(19) United States
(12) Patent Application Publication
(10) Pub. No.: US 2022/0118543 A1
(43) Pub. Date: Apr. 21, 2022

(54) WELDING WIRE FOR DISSIMILAR WELDING OF CU AND STEEL AND PREPARATION METHOD THEREOF AND METHOD FOR WELDING CU AND STEEL

(71) Applicants: Dalian University of Technology, Dalian City (CN); Ningbo Institute of Dalian University of Technology, Ningbo (CN)

(72) Inventors: Yubo ZHANG, Dalian City (CN); Tingju LI, Dalian City (CN); Jinchuan JIE, Dalian City (CN); Shipeng YUE, Dalian City (CN); Shichao LIU, Dalian City (CN); Tongmin WANG, Dalian City (CN); Zhiqiang CAO, Dalian City (CN); Yiping LU, Dalian City (CN); Huijun KANG, Dalian City (CN); Zongning CHEN, Dalian City (CN); Enyu GUO, Dalian City (CN)

(73) Assignees: Dalian University of Technology, Dalian City (CN); Ningbo Institute of Dalian University of Technology, Ningbo (CN)

(21) Appl. No.: 17/132,059

(22) Filed: Dec. 23, 2020

(30) Foreign Application Priority Data
Oct. 16, 2020 (CN) 202011107044.6

(51) Int. Cl. B23K 9/23; B23K 35/02; B23K 35/30; C22C 9/00; C22F 1/08; B23K 9/235

(52) U.S. Cl. CPC B23K 9/232; B23K 35/0261; B23K 35/302; B23K 2103/22; C22F 1/08; B23K 9/235; C22C 9/00

(57) ABSTRACT

The present disclosure relates to the technical field of dissimilar welding of Cu and a steel, and in particular to a welding wire for dissimilar welding of Cu and a steel and a preparation method thereof and a method for welding Cu and a steel. The present disclosure provides a welding wire for dissimilar welding of Cu and a steel, including, in percentages by mass, 5-25% of iron phase, less than 0.1% of inevitable impurities, and copper matrix. The welding wire of the present disclosure, containing two elements, i.e. copper and iron, is conducive to the mixing of the two phases—copper and iron—during the welding process, to form a mutual soluble region, thereby makes it possible to greatly increase the weldability, reduce the width of the weld, effectively overcome the tendency of cracks, and thus to ensure the formed weld with a high crack resistance.

### CROSS REFERENCE TO RELATED APPLICATION

This application claims the priority of Chinese Patent Application No. 202011107044.6, entitled “Welding wire for dissimilar welding of Cu and steel and preparation method thereof and method for welding Cu and steel” filed with the China National Intellectual Property Administration on Oct. 16, 2020, which is incorporated herein by reference in its entirety.

### TECHNICAL FIELD

The present disclosure relates to the technical field of dissimilar welding of Cu and a steel, and in particular to a welding wire for dissimilar welding of Cu and a steel, a preparation method thereof, and a method for welding Cu and a steel.

### BACKGROUND

As well known, the composite structural component of dissimilar metals—Cu and a steel—has combined advantages of bimetal, and thereby makes it possible to combine the good electric conductivity and thermal conductivity of copper alloy with the high toughness, high strength, high hardness and wear resistance of a steel, to achieve the complementary advantages of the performance and economic, and to meet requirements for the performance of some special structural parts in industrial practice while reducing costs. The composite structural component of dissimilar metals—Cu and a steel—is widely used in many fields such as aerospace, petrochemical industry, power station boiler, nuclear power and machinery. With the continuous expansion of the application fields of the composite structural component of dissimilar metals—Cu and a steel, the main welding process for preparing the composite structural component of dissimilar metals—Cu and a steel—has been paid more attention.

There are huge differences in the physical and chemical properties between Cu and a steel, and as a result, welding defects such as cracks, pores may occur in the welding of dissimilar metals—Cu and a steel. Therefore, proper welding is the key to ensure good weld formation and excellent joint performance for the dissimilar welding of Cu and a steel.

Among the existing methods for welding Cu and a steel, common welding wires includes pure copper, CuSi₃, stainless steel and nickel-based welding wires, etc. However, there are huge differences in the physical and chemical properties between Cu and a steel, it is extremely difficult to achieve that copper and iron are miscible with each other, and it is not easy to make the two phases miscible with a single-component welding wire, while the newly added elements may also form intermetallic compound phases, affecting the welds strength. As a result, welding defects such as cracks, pores may easily occur in the dissimilar welding of Cu and a steel.

Cu—Fe alloy is an ideal welding wire for the dissimilar welding of Cu and a steel. The Cu—Fe alloy, containing Cu element and Fe element, is conducive to the mixing of the two phases—copper and iron—during the welding process, to form a mutual soluble region, thereby improving the weldability of Cu and a steel. Meanwhile, the Cu—Fe alloy is conducive to overcoming the tendency of cracks, and thereby makes it possible to ensure the formed weld with a high crack resistance. The Cu—Fe alloy is immiscible, and it will separate during the solidification, so it is difficult to obtain a uniform solidification structure, and it is easy to occur serious phase separation or most component segregation, and the component segregation would seriously and adversely affect the mechanical properties and plastic processing properties of the material.

Therefore, it is a difficult problem that how to prepare high-quality Cu—Fe alloy welding wire and ensure the formed weld with a high crack resistance.

### SUMMARY

An objective of the present disclosure is to provide a welding wire for dissimilar welding of Cu and a steel, a preparation method thereof, and a method for welding Cu and a steel, and the welding wire makes it possible to ensure the formed weld with a high crack resistance.

In order to achieve the above objective, the present disclosure provides the following technical solutions:

The present disclosure provides a welding wire for dissimilar welding of Cu and a steel, comprising, in percentages by mass, 5-25% of iron phase, less than 0.1% of inevitable impurities, and the balance of copper matrix.

In some embodiments, the copper matrix has a face-centered cubic structure.

In some embodiments, the iron phase may be a commercial-purity iron.

In some embodiments, the iron phase may be a-Fe.

The present disclosure further provides a method for preparing the welding wire as described in the above technical solutions, comprising the following steps:

smelting and casting raw materials according to components of the welding wire, to obtain a Cu—Fe alloy;

subjecting the Cu—Fe alloy to a homogenization, a hot-extrusion deformation preprocessing, a cold-drawing deformation, and an annealing in sequence, to obtain the welding wire.

In some embodiments, the smelting comprises the following steps:

melting copper and keeping the molten copper at a temperature of 1250-1300° C. for 10-15 min, and then adding a pure iron for smelting;

wherein the smelting is performed at a temperature of 1400-1550° C. for 45-50 min.

In some embodiments, the casting comprises using a cast-iron casting mould or a graphite casting mould as a casting mould, and before the casting preheating the casting mould at a temperature of 400-500° C.

In some embodiments, the homogenization is performed at a temperature of 950-1000° C. for 3-4 h;

In some embodiments, the hot-extrusion deformation preprocessing is conducted at a temperature of 600-800° C.

In some embodiments, the cold-drawing deformation processing is a multi-pass cold-drawing deformation processing, the deformation amount for each pass cold-drawing deformation processing is in a range of 0.3-1.0 mm, and the total deformation amount is in a range of 6-9 mm.

In some embodiments, annealing is performed once between every 1-5 pass cold drawing processing, and the annealing is performed at a temperature of 550-680° C. for 0.5-1 h.

The present disclosure further provides a method for welding Cu and a steel, comprising the following steps:

fixing a steel plate and a copper plate by a solder joint, and

welding the fixed steel plate and copper plate by an argon arc welding,

wherein the argon arc welding comprises using the welding wire as described in the above technical solutions or the welding wire as prepared by the method as described in the above technical solutions.

In some embodiments, the argon arc welding is performed with a welding current of 80-150 A, a welding voltage of 10-15 V, a wire feeding speed of 3-6 mm/s, and a welding speed of 1 mm/s.

In some embodiments, argon is used as a shielding gas of the argon arc welding, with an argon flow of 10-20 L/min.

The present disclosure provides a welding wire for dissimilar welding of Cu and a steel, comprising in percentages by mass, 5-25% of iron phase, less than 0.1% of inevitable impurities, and the balance of copper matrix. The welding wire of the present disclosure, containing two elements, i.e. copper and iron, is conducive to the mixing of the two phases—copper and iron—during the welding process, to form a mutual soluble region, thereby greatly improving the weldability. Because the welding wire only contains two elements i.e. copper and iron, no other new phases could be formed during the process of welding, meanwhile, the formed weld with the Cu—Fe welding wire is narrow, and the melting area is small, which reduces the width of the weld, effectively overcomes the tendency of cracks, and makes it possible to ensure the formed weld with a high crack resistance.

The present disclosure further provides a method for preparing the welding wire as described in the above technical solutions, comprising the following steps: smelting and casting raw materials according to components of the welding wire, to obtain a Cu—Fe alloy; subjecting the Cu—Fe alloy to a homogenization processing, a hot-extrusion deformation preprocessing, a cold-drawing deformation processing, and an annealing in sequence, to obtain the welding wire. Due to the fact that an structure of “copper matrix and dendrite iron” is formed during the smelting process, the higher Fe content, the easier to produce the iron phase segregation, and to produce coarse dendrite iron. The coarse dendrite iron can not only adversely affect the mechanical properties of the Cu—Fe alloy, but also adversely affect the plastic processing, and easily cause fracture during the extrusion and drawing processing. In the present disclosure, with the above method, it is possible to control the microstructure of Cu—Fe alloy as-cast to “copper matrix and fine dispersed iron phase”, thereby improving the mechanical properties and processing properties of the alloy.

### BRIEF DESCRIPTION OF THE DRAWINGS

FIG. 1 shows a pictorial diagram (a), a cross-section metallographic structure diagram (b) and a longitudinal-section metallographic structure diagram (c) of the welding wire as prepared in Example 1.

FIG. 2 shows microstructure diagrams of the weld obtained with the welding wire of Example 1 and the weld obtained in Comparative Example 1.

FIG. 3 shows a X-ray diffraction (XRD) pattern of the welding wire as prepared in Example 1.

### DETAILED DESCRIPTION

The present disclosure provides a welding wire for dissimilar welding of Cu and a steel, comprising, in percentages by mass, 5-25% of iron phase, less than 0.1% of inevitable impurities, and the balance of copper matrix.

The welding wire provided by the present disclosure comprises 5-25% by mass of iron phase. In some embodiments, the welding wire comprises 10-20% by mass of iron phase, more preferably 14-18% by mass. In some embodiments, the iron phase is uniformly distributed in the copper matrix.

The welding wire provided by the present disclosure comprises less than 0.1% by mass of inevitable impurities, preferably 0.01-0.03% by mass.

In addition to the above components, the welding wire further comprises the balance of copper matrix. In some embodiments, the copper matrix has a face-centered cubic structure.

In some embodiments, the welding wire has a diameter of 1-2 mm, a hardness of 160-200 Hv, and a strength of 600-1000 MPa.

The present disclosure further provides a method for preparing the welding wire as described in the above technical solutions, comprising the following steps:

smelting and casting raw materials according to components of the welding wire, to obtain a Cu—Fe alloy;

subjecting the Cu—Fe alloy to a homogenization, a hot-extrusion deformation preprocessing, a cold-drawing deformation processing and an annealing in sequence, to obtain the welding wire.

According to the present disclosure, unless otherwise stated, all raw materials are commercially available products known to those skilled in the art.

In the present disclosure, the smelting and casting of raw materials are performed according to the components of the welding wire, to obtain a Cu—Fe alloy. According to the present disclosure, in some embodiments, the raw materials used for the smelting are industrial pure copper and industrial pure iron; the industrial pure copper and industrial pure iron independently have a purity of larger than 99.7%. In some embodiments, before the smelting, the raw materials are subjected to a pickling, an ultrasonic cleaning and a drying in sequence. There are no special restrictions for the pickling in the present disclosure, and it is possible to use any pickling method known to those skilled in the art, as long as the oxide layer and impurities on the surface of the raw materials could be removed. According to the present disclosure, in some embodiments, the ultrasonic cleaning is carried out in anhydrous ethanol. There are no special restrictions for the ultrasonic cleaning condition(s) in the present disclosure, it is possible to use any ultrasonic cleaning condition(s) known to those skilled in the art. According to the present disclosure, in some embodiments, the drying is preformed at a temperature of 60° C. for 30 min.

According to the present disclosure, the smelting comprises the following steps: melting copper and keeping the molten copper at a temperature of 1250-1300° C. for 10-15 min, and adding a pure iron for smelting. In some embodiments, the smelting comprises the following steps: melting copper and keeping the molten copper at a temperature of 1260-1280° C. for 12-13 min, and adding a pure iron for smelting. According to the present disclosure, in some embodiments, the melting is performed at a temperature of 1400-1550° C., preferably 1450-1500° C., for 45-50 min. According to the present disclosure, in some embodiments, the smelting is carried out in vacuum medium frequency induction melting furnace.

According to the present disclosure, the smelting is to fully mix copper and iron in the liquid phase, and avoid liquid phase separation or iron phase agglomeration, to obtain an ingot with an uniform structure and composition.

According to the present disclosure, in some embodiments, the casting comprises: casting the alloy melt obtained from the melting to the casting mould. According to the present disclosure, in some embodiments, the casting mould is a cast-iron casting mould or a graphite casting mould, more preferably a cast-iron casting mould. According to the present disclosure, in some embodiments, the casting mould is shaped as cylindrical. In some embodiments, before the casting, the method further comprises preheating the casting mould, and the preheating is preformed at a temperature of 400-500° C.

According to the present disclosure, the casting is to enable the Cu—Fe alloy melt to pass through the metastable immiscible region rapidly during the solidification process, to avoid liquid phase separation, and thus to obtain a solidification structure, in which the iron phase is uniformly distributed in the copper matrix.

After the Cu—Fe alloy is obtained, the Cu—Fe alloy is subjected to a homogenization processing, a hot-extrusion deformation preprocessing, a cold-drawing deformation preprocessing and an annealing in sequence, to obtain the welding wire.

According to the present disclosure, in some embodiments, the homogenization processing is performed at a temperature of 950-1000° C., preferably 960-980° C. In some embodiments, the homogenization processing is performed for 3-4 h, preferably for 3.2-3.6 h.

According to the present disclosure, the homogenization is to reduce the composition segregation in the solidification structure, to eliminate the casting stress, to improve the internal structure and performance of the casting billet, and is conductive to the subsequent extrusion and drawing processing.

In some embodiments, after the homogenization, the method further comprises removing oxide scales on the obtained bar surface by means of mechanical processing.

According to the present disclosure, in some embodiments, the hot-extrusion deformation preprocessing is performed at a temperature of 600-800° C., preferably 650-750° C., for example 700° C. There are no special restrictions for the pressure and time of the hot-extrusion deformation preprocessing in the present disclosure, and it is possible to use any pressure and time known to those skilled in the art. According to the present disclosure, in some embodiments, the obtained copper-iron alloy casting ingot after the hot-extrusion deformation preprocessing is a round ingot with a diameter of 8-10 mm.

According to the present disclosure, the hot-extrusion deformation preprocessing is to process the copper-iron alloy ingot obtained from the casting into a round rod that is suitable for drawing.

According to the present disclosure, in some embodiments, the cold-drawing deformation preprocessing is a multi-pass cold drawing deformation preprocessing. There are no special restrictions for the process of each pass cold-drawing deformation preprocessing in the present disclosure, and it is possible to use any process known to those skilled in the art, with the proviso that the deformation amount of each cold-drawing deformation preprocessing is in a range of 0.3-1.0 mm. According to the present disclosure, in some embodiments, the total deformation amount is in a range of 6-9 mm, preferably 8 mm. According to the present disclosure, the deformation amount can be understood as the difference in diameter before and after the deformation.

According to the present disclosure, the cold-drawing deformation preprocessing is to obtain the Cu—Fe alloy welding wires with a standard size of use.

According to the present disclosure, in some embodiments, annealing is performed once between every 1-5 pass cold drawing processing. In some embodiments, the annealing is performed at a temperature of 550-680° C., preferably 580-630° C., more preferably 600-620° C. In some embodiments, the annealing is performed for 0.5-1 h, preferably 0.6-0.8 h.

According to the present disclosure, the annealing is to eliminate stress.

The present disclosure further provides a method for welding Cu and a steel, comprising the following steps:

fixing a steel plate and a copper plate by a solder joint, and

welding the fixed steel plate and copper plate by an argon arc welding,

wherein the argon arc welding comprises using the welding wire as described in the above technical solutions or the welding wire prepared by the method as described in the above technical solutions.

In the present disclosure, a steel plate and a copper plate are fixed by a solder joint. According to the present disclosure, in some embodiments, under the condition that the thickness of the steel plate or the copper plate is not less than 100 mm, the steel plate or the copper plate is preheated before the fixing by a solder joint. In some embodiments, the preheating is performed at a temperature of 200° C. In some embodiments, the preheating is performed for 10 min. There are no special restrictions for the category of the steel plate or the copper plate in the present disclosure, and it is possible to use any steel plate or copper plate known to those skilled in the art. There are no special restrictions for the process of the fixing in the present disclosure, and it is possible to use any process known to those skilled in the art.

After the fixing, the fixed steel plate and copper plate are weld by an argon arc welding; the welding wire used in the argon arc welding is the welding wire as described in the above technical solutions or the welding wire prepared by the method as described in the above technical solutions. According to the present disclosure, in some embodiments, the argon arc welding is performed with a welding current of 80-150 A, preferably 90-130 A, and more preferably 100-120 A. In some embodiments, the argon arc welding is performed with a welding voltage of 10-15 V, preferably 12-13 V. In some embodiments, the argon arc welding is performed with a wire feeding speed of 3-6 mm/s, preferably 4-5 mm/s. In some embodiments, the argon arc welding is performed with a welding speed of 1 mm/s. According to the present disclosure, in some embodiments, argon is used as a shielding gas of the argon arc welding, with an argon flow of 10-20 L/min, preferably 12-18 L/min, and more preferably 14-16 L/min.

Technical solutions of the present disclosure will be clearly and completely described below with reference with examples of the present disclosure. It is evident that the described examples are only a part of the examples of the present disclosure and not all of them. Based on the examples of the present disclosure, all other examples obtained by ordinary of skilled in the field without creative labor shall fall within the scope of the present disclosure.

### Example 1

Industrial pure copper and industrial pure iron (both with a purity of larger than 99.7%) were pickled to remove oxide scales, ultrasonically cleaned in absolute ethanol, and then dried at a temperature of 60° C. for 30 min.

8 kg of pretreated industrial pure copper was placed into a ceramic crucible and heated to melt, the molten copper was kept at a temperature of 1300° C. for 15 min, then 2 kg of industrial pure iron was added, and the resulting system was kept at a temperature of 1600° C. for 50 min to obtain an alloy melt. The obtained alloy melt was cast into a cylindrical cast-iron mold, obtaining a Cu-20Fe alloy with a diameter of 80 mm.

The Cu—Fe alloy was in sequence subjected to a homogenization at 950° C. for 4 h, a mechanical processing to remove the surface oxide scales, and a hot-extrusion deformation preprocessing at 700° C., obtaining a round ingot with a diameter of 10 mm.

The obtained round ingot with a diameter of 10 mm was subjected to multiple-passes cold drawing processing at ambient temperature, and the deformation amount for each pass was 1 mm for a diameter greater than 5 mm, was 0.5 mm for a diameter of 3-5 mm, and was 0.3 mm for a diameter less than 3 mm. After 5 passes cold drawing, when the diameter became 5 mm, annealing was performed once at 650° C. for 0.5 h; after another 4 passes cold drawing, when the diameter became 3 mm, annealing was performed once at 650° C. for 0.5 h; when the diameter was reduced to 2 mm, annealing was performed once at 650° C. for 0.5 h, obtaining a welding wire with a cross-sectional diameter of 2 mm;

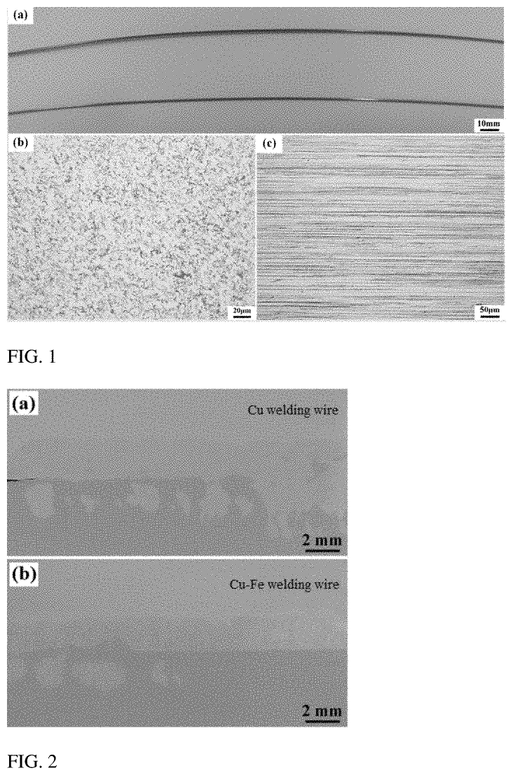

FIG. 1 shows graphs of the welding wire, in which (a) shows a pictorial diagram of the welding wire, (b) shows a cross-section metallographic structure of the welding wire, and (c) shows a longitudinal-section metallographic structure of the welding wire; in which the light color is the copper matrix having a face-centered cubic structure, and the dark color is the fine dispersed iron phase, and the iron phase is uniformly dispersed in the copper matrix having a face-centered cubic structure.

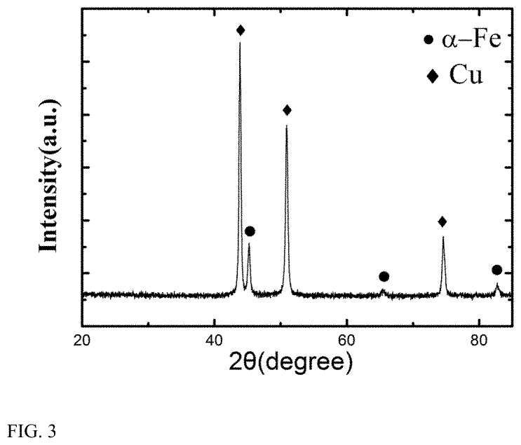

The welding wire was subjected to an XRD test, and the test result is shown in FIG. 3. As shown in FIG. 3, the welding wire of the present disclosure includes iron phase and copper, and the copper has a face-centered cubic structure.

### Example 2

Industrial pure copper and industrial pure iron (both with a purity larger than 99.7%) were pickled to remove oxide scale, ultrasonically cleaned in absolute ethanol, and then dried at a temperature of 60° C. for 30 min.

9 kg of pretreated industrial pure copper was placed into a ceramic crucible and heated to melt, the molten copper was kept at a temperature of 1300° C. for 15 min, then 1 kg of industrial pure iron was added, and the resulting system was kept at a temperature of 1500° C. for 30 min to obtain an alloy melt. The obtained alloy melt was cast into a cylindrical cast-iron mold, obtaining a Cu-10Fe alloy with a diameter of 80 mm.

The Cu—Fe alloy was in sequence subjected to a homogenization processing at 930° C. for 4 h, a mechanical processing to remove the surface oxide scales, and a hot-extrusion deformation preprocessing at 650° C., obtaining a round ingot with a diameter of 10 mm.

The obtained round ingot with a diameter of 10 mm was subjected to multiple-passes cold drawing at ambient temperature, and the deformation amount for each pass was 1 mm for a diameter greater than 5 mm, and was 0.5 mm for a diameter of 2-5 mm. After 5 passes cold drawing, when the diameter became 5 mm, annealing was performed once at 630° C., 2 h; after another 3 passes cold drawing, when the diameter became 3.5 mm, annealing was performed once at 630° C., for 2 h; the cold drawing was continued until the diameter was reduced to 2 mm, obtaining a welding wire with a cross-sectional diameter of 2 mm.

### Example 3

The welding wires as prepared in Examples 1-2 were used to weld a pure copper plate and a low-carbon steel plate, each of which has a thickness of 3 mm, by an argon arc welding.

The pure copper plate and the low-carbon steel plate were fixed by a solder joint.

The fixed steel plate and copper plate were weld by an argon arc welding, and the welding was conducted under the following conditions: a welding current of 80 A, a welding voltage of 10 V, a wire feeding speed of 3 mm/s, a welding speed of 1 mm/s, and argon with a purity of 99.9% was used as the shielding gas, with an argon flow of 15 L/min.

### Comparative Example 1

Pure-copper welding wire was used to weld a pure copper plate and a low-carbon steel plate, each of which has a thickness of 3 mm, by an argon arc welding.

The pure copper plate and low-carbon steel plate were fixed by a solder joint.

The fixed steel plate and copper plate were weld with an argon arc welding, and the welding was conducted under the following conditions: a welding current of 80 A, a welding voltage of 10 V, a wire feeding speed of 3 mm/s, a welding speed of 1 mm/s, and argon with a purity of 99.9% was used as a shielding gas, an argon flow of 15 L/min.

FIG. 2 shows a microstructure diagram of the weld obtained with the welding wire in Example 1 and the weld obtained in Comparative Example 1. As shown in FIG. 2, the weld obtained with the welding wire of Example 1 is narrower, the structure of the weld is more uniform, and there are no pores and crack defects.

The mechanical strength of the weld was measured according to GB/T228.1-2010, and the test results are shown in Table 1.

TABLE 1
Tensile strength of the welds obtained with the welding wires of
Examples 1-2 and the weld obtained in Comparative Example 1.

| | | | Comparative |
|---|---|---|---|
| weld | Example 1 | Example 2 | Example 1 |
| strength (MPa) | 250 | 220 | 180 |

The examples as described above are only the preferred embodiments of the present disclosure. It should be understood that for those skilled in the art, several improvements and modifications could be made without departing from the principle of the present disclosure, and those improvements and modifications shall be within the scope of the present disclosure.

What is claimed is:

1. A welding wire for dissimilar welding of Cu and a steel, comprising, in percentages by mass, 5-25% of iron phase, less than 0.1% of inevitable impurities, and the balance of copper matrix.

2. The welding wire as claimed in claim 1, wherein the copper matrix has a face-centered cubic structure.

3. A method for preparing the welding wire as claimed in claim 1, comprising:
smelting and casting raw materials according to components of the welding wire, to obtain a Cu—Fe alloy, and
subjecting the Cu—Fe alloy to a homogenization, a hot-extrusion deformation preprocessing, a cold-drawing deformation processing, and an annealing in sequence, to obtain the welding wire.

4. The method as claimed in claim 3, wherein the smelting comprising:
melting copper and keeping the molten copper at a temperature of 1250-1300° C. for 10-15 min, and adding pure iron for smelting,
wherein the smelting is performed at a temperature of 1400-1550° C. for 45-50 min.

5. The method as claimed in claim 3, wherein the casting comprises using a cast-iron casting mould or a graphite casting mould as a casting mould;
further comprising before the casting, preheating the casting mould at a temperature of 400-500° C.

6. The method as claimed in claim 3, wherein the homogenization is performed at a temperature of 950-1000° C. for 3-4 h;
the hot-extrusion deformation preprocessing is conducted at a temperature of 600-800° C.

7. The method as claimed in claim 3, wherein the cold-drawing deformation processing is a multi-pass cold-drawing deformation processing, a deformation amount for each pass cold-drawing deformation processing is in a range of 0.3-1.0 mm, and the total deformation amount is in a range of 6-9 mm.

8. The method as claimed in claim 3, wherein annealing is performed once between every 1-5 passes cold-drawing deformation processing;
the annealing is performed at a temperature of 550-680° C. for 0.5-1 h.

9. A method for welding Cu and a steel, wherein comprising:
fixing a steel plate and a copper plate by a solder joint, and
welding the fixed steel plate and copper plate by an argon arc welding,
wherein the argon arc welding comprises using the welding wire as claimed in claim 1.

10. The method as claimed in claim 9, wherein the argon arc welding is performed with a welding current of 80-150 A, a welding voltage of 10-15 V, a wire feeding speed of 3-6 mm/s, and a welding speed of 1 mm/s, and argon is used as a shielding gas of the argon arc welding, with an argon flow of 10-20 L/min.

11. The welding wire as claimed in claim 1, wherein the iron phase is α-Fe.
